(19) United States
(12) Patent Application Publication
(10) Pub. No.: US 2001/0022266 A1
(43) Pub. Date: Sep. 20, 2001

(54) Safety system for a car door

(76) Inventor: Thierry Benard, Paris (FR)

Correspondence Address: Longacre & White, Suite 240, 6550 Rock Spring Drive, Bethesda, MD, 20817, US

(21) Appl. No.: 09/780,448

(22) Filed: Feb. 12, 2001

(30) Foreign Application Priority Data
Feb. 11, 2000 (FR) 0001697

(51) Int. Cl. H01H 27/06

(52) U.S. Cl. 200/61.64

(57) ABSTRACT

Safety system for a car door comprising a handle with an external gripping lever, hinged on a support (1) fitted on the inside of a bodywork panel (2), this handle being controllable by a user to open a door lock. Means are provided to detect movement of the lever. They comprise a bulb (8) containing “reed” type contacts (9) and a magnet (9), between which a passageway (16) is formed along which a part (10) forming a magnetic screen can be moved using the lever. This part moves from a position in which the lever is in the rest position with the contacts being in a first state, to at least one position starting from which the contacts move into a second state when the lever is moved from its rest position. These detection means are used together with means of detecting when a hand is close to the handle.

The invention relates to a safety system for a car door, including means of detecting an initial manual movement of a door control handle.

This control handle is assumed to be of the type in which a gripping lever is installed on the outside of a bodywork panel of the door, and is hinged on a support that is mounted on the inside of the panel. The gripping lever is designed so that a user can move it from a rest position, so that it acts upon a lock holding the door in the closed position.

In one known embodiment, the system comprises means of remote detection of a hand being present close to the gripping lever and particularly between the lever and the panel, for example by electromagnetic radiation. This detection is used to control action on the vehicle, for example unlocking the door under specific conditions.

In one known embodiment, there are also additional detection means provided for safety purposes, in order to compensate a failure in the electromagnetic means. These additional means detect when the gripping lever is moved. They include an auxiliary lever that can act on a two-position switch to move it from one position to another when the gripping lever is moved. The auxiliary lever is mechanically linked to the gripping lever for this purpose.

However, the mechanism used to control a switch from the gripping lever does have some disadvantages, to the extent that it must be made within relatively strict tolerances for manufacturing and particularly for mounting the assembly making up the gripping lever, the switch and the various intermediate parts necessary for transmission of movements from one part to the other, in order to obtain and maintain safe and reliable operation in the long term.

This is why a search is made for alternative and simpler solutions to provide at least equal reliability with wider tolerances in order to facilitate manufacturing, particularly during assembly, and to reduce costs.

Therefore, the invention proposes a safety system for a car door comprising a control handle including an external gripping lever that is hinged on a handle support fitted on the inside of a bodywork panel, this handle being controllable by a user from a rest position and at least as far as an open position to control a lock that keeps the door in the closed position, the system comprising means of detecting movement of the gripping lever from its rest position.

According to one characteristic of the invention, these movement detection means include a bulb containing “reed” type contacts and a control magnet, between which a passageway is formed along which a part forming a magnetic screen can move from an initial position in which the gripping lever is in the rest position and the contacts are in a first switching state, to at least one second position starting from which the contacts move into a second switching state when the gripping lever is moved from its rest position.

According to one characteristic of the invention, these means of detection of the movement of the gripping lever from its rest position are associated with remote means of detection of a hand present close to the handle by means of an electromagnetic signal to overcome a possible failure of the said remote detection means.

According to the invention, the magnetic screen is supported by an auxiliary lever driven by movement of the gripping lever, in order to slide in a passageway consisting of a projecting closed hole between the bulb and the magnet, inside a housing in which initial detection means are arranged and which operate in association with the contacts.

According to the invention, the remote detection means and movement detection means are at least partially grouped in a housing which in particular contains the bulb containing the contacts and the control magnet for the said movement detection means, and the transmitter and receiver of the remote detection means, the bulb and the magnet being arranged on opposite sides of a passageway along which the part forming the magnetic screen is free to move longitudinally, the said passageway penetrating into the housing and on the outside being in the form of a closed hole opening towards the outside the housing.

The invention, and its characteristics and advantages are described in more detail in the following description with relation to the figures mentioned above.

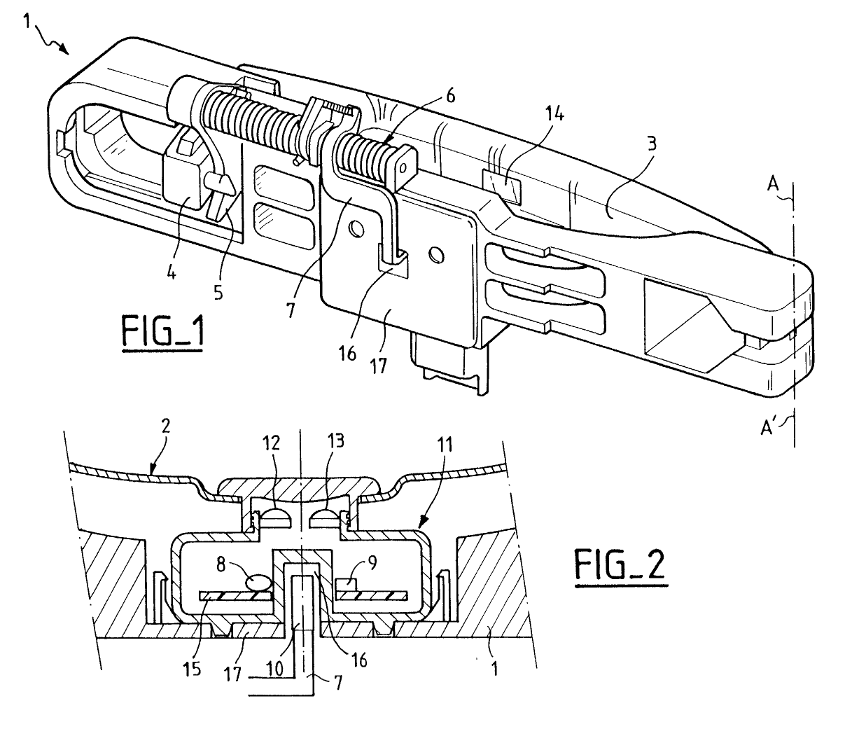

FIG. 1 is a perspective view of an example assembly for a car door, showing a lever for gripping a door control handle, a handle support on which the gripping lever is hinged, and an intermediate transfer device between the gripping lever and means of detecting movement of the gripping lever.

FIG. 2 is a sectional view of a housing containing detection means for a safety system according to the invention, this view being rotated by 90° in the clockwise direction from the previous view.

The safety system according to the invention is designed for use on a known type of car door fitted with a control handle installed on a support 1 (see FIGS. 1 and 2). The support is designed to be positioned in contact with the internal face of a bodywork panel 2 forming the door and that will be fitted with a gripping lever 3. This lever 3 is installed on the outside of the external panel 2 through which it passes and is hinged at the end on the handle support 1 at a centerline AA′ at the end of this support. The other end of the gripping lever also passes through the external panel to cooperate through an attachment leg 4 with a rotary latch 5 of an intermediate movement transmission device 6 mechanically connecting the gripping lever to an auxiliary lever 7 that acts on means of detecting the movement of a safety system.

Manual movement of the gripping lever 3 from an initial rest position acts on the rotary latch that drives the auxiliary lever 7 from a first position and beyond a second position, after the gripping lever has traveled a determined distance. As is known to an expert in the field, the second position of the auxiliary lever may be chosen, depending on the needs, for example to correspond to an intermediate position of the gripping lever during its travel starting from its initial position, or the position of this gripping lever at the limit switch. It should also be understood that the displacement directions of the auxiliary lever 7 and the gripping lever 3 may be obtained in the same or in opposite directions depending on needs, simply by adapting the intermediate movement transmission device 6, in a manner known to an expert in the field.

In any case, the safety system allows for combining means of detecting relative movement of the gripping lever with this door handle assembly.

In one particular embodiment, the safety system combines means of detecting the movement of the gripping lever with means, for example electromagnetic means, of remote detection of the presence of a hand close to the handle of which this gripping lever 3 forms part. For example, this association may be provided for safety purposes to overcome a possible failure of the electromagnetic remote detection means.

In this case, the movement of the gripping lever 3 is detected through a relay composed of “reed” type contacts that are encapsulated in a sealed bulb, such as an ILS bulb made by the CELDUC company and which are magnetically connected to each other or disconnected depending on whether or not a magnetic field is present. This field is created by a control magnet 9. This is why the magnet 9 is associated with bulb 8 in which the contacts are encapsulated in an assembly in which a passageway 16 is formed in which a magnetic screen 10 can be inserted between this magnet and this bulb as shown in FIG. 2. As is already known, the presence of a screen between the bulb and the magnet causes the contacts to be positioned in a first switching state, and removal of the screen will cause them to be positioned in a second state.

The magnetic screen 10, which may for example be in the form of a fixed metal blade, for example glued to the end of the auxiliary lever 7. This blade is housed in the passageway formed for it between the bulb and the magnet and is retracted by an auxiliary lever 7. When the gripping lever is moved from its rest position, the magnetic field of the magnet 9 acts on contacts contained in the bulb that are electrically connected to a circuit that detects the change that occurred and informs the safety system about the result. The safety system is not described in detail here, and for example may include programmed control logic in order to make use of the information supplied.

When the safety system comprises remote detection means and these means comprise a radiation transmitter and receiver 12 and 13, they may for example be laid out in a known manner in a housing 11 that is preferably sealed. This housing contains the transmitter 12 and the receiver 13 (FIG. 2) that face a reflector 14 (FIG. 1) fitted on the gripping lever 3 to return radiation produced by the transmitter to the receiver if there is no obstacle, particularly a hand, along the path followed by the radiation between the housing fitted on the handle support 1 and the gripping lever fitted on this support.

In one preferred embodiment, the bulb 8 and the magnet 9 are housed in the housing 11 in which they are mounted on a component support plate 15, for example such as a printed circuit board. This board is open, for example at its center, to enable the screen to pass between the bulb and the magnet.

In the embodiment described, the board 15 surrounds a screen passageway 16 that projects inside the housing 11 and from the outside looks like a closed hole opening beyond the bottom of the housing on the side opposite to an opening in which the transmitter 12 and the receiver 13 are located. The passageway 16 is placed in an opening formed in the wall 17 of the handle support 1, the bottom of the housing being placed in contact with this support so that the screen 10 can move backwards and forwards inside the passageway when the auxiliary lever 7 is moved in contact with the gripping lever 3. The resulting layout makes it possible to at least partially group movement detection means and presence detection means in a single housing, in this case assumed to be removable and positioning itself and click fitting onto support 1 at the bottom of a recess provided for it.

1. Safety system for a car door comprising a control handle including an external gripping lever (3) that is hinged on a handle support (1, this lever being controllable by a user from a rest position and at least as far as an open position to control a lock that keeps the door in the closed position, the system comprising means of detecting movement of the gripping lever from its rest position, characterized in that these movement detection means include a bulb (8) containing “reed” type contacts and a control magnet (9), between which a passageway (16) is formed along which a part (10) forming a magnetic screen can move from an initial position in which the gripping lever is in the rest position and the contacts are in a first switching state, to at least one second position starting from which the contacts move into a second switching state when the gripping lever is moved from its rest position.

2. Safety system according to claim 1, in which the part forming a magnetic screen is supported by an auxiliary lever (7), mechanically connected to the gripping lever through a intermediary movement transmission device 6.

3. Safety system according to one of claims 1 and 2, in which the means (8, 9, 10) of detecting a movement of the gripping lever from its rest position are used alongside means (12, 13, 14) of remote detection of a hand being present close to the handle, by means of an electromagnetic signal, to overcome a possible failure of the said remote detection means.

4. Safety system according to claim 3, in which the remote detection means and movement detection means are at least partially grouped in a housing (11) which in particular contains the bulb (8) and the magnet (13) of the said contains the bulb (8) and the magnet (13) of the said movement detection means, and the transmitter (12) and receiver (13) of the remote detection means, the bulb and the magnet being arranged on opposite sides of a passageway (16) along which the part (10) forming the magnetic screen is free to move longitudinally, the said passageway penetrating into the housing and on the outside being in the form of a closed hole opening towards the outside of the housing.
